(19) United States
(12) Patent Application Publication
(10) Pub. No.: US 2016/0044123 A1
(43) Pub. Date: Feb. 11, 2016

(54) WEBSITE APPLICATION CACHING MECHANISM

(71) Applicant: GREENMAN GAMING LIMITED, London (GB)

(72) Inventors: Lee PACKHAM, London (GB); Malgorzata JURKIEWICZ, London (GB); Rob MOORE, Bexleyheath (GB); Krzysztof BANDURSKI, London (GB); Dean ELBAZ, London (GB)

(21) Appl. No.: 14/820,981

(22) Filed: Aug. 7, 2015

Related U.S. Application Data
(60) Provisional application No. 62/034,493, filed on Aug. 7, 2014.

(51) Int. Cl. H04L 29/08

(52) U.S. Cl. CPC H04L 67/2814; H04L 67/1014; H04L 67/2842

(57) ABSTRACT

The present invention relates to a method for website application caching. The method includes the steps of receiving a POST request from a requester; processing the POST request at a server; on the basis of the processing, redirecting the POST request to one of a plurality of GET requests; retrieving a web resource from a cache using the redirected GET request; and transmitting the web resource to the requester. A system for website application caching is also disclosed.

### FIELD OF INVENTION

The present invention is in the field of website application caching. More particularly, but not exclusively, the present invention relates to an improved caching mechanism for website applications.

### BACKGROUND

Websites deliver content to requesters. Requesters makes requests over either HTTP or HTTPS to Internet servers. These Internet servers respond to the requests by transmitting the stored webpage to which the request relates or dynamically generating and transmitting the website.

This mechanism is inefficient because generally a single web server must manage all the inbound requests. To improve this inefficiency and to enable the delivery of web-pages where there is a high frequency of requests, many systems implement server-side caching. This caching mechanism stores the web-pages in a cache before the web server. When a request comes in that relates to the web-page it is delivered from the cache rather than hitting the web server.

Some caching mechanisms are automatic, such as Varnish. Varnish detects the request and web-pages delivered by the web server and caches the most frequently served web-pages.

There are two common ways of providing request-response via HTTP/HTTPS.

The first is the GET HTTP request. This request identifies the required web-page by URL. Data can be provided to the web-server by including query strings within the URL. This request can be cached but different information within the query strings result in a separate cached web-page for each request. This results in the cache filling up quickly with web-pages that are only delivered once. This results in a cache system which is both slow and memory inefficient.

The second is a POST request. This request submits data to be processed by the resource identified by URL. The data is provided within HTTP message body of the POST request rather than the URL. POST requests cannot be cached. This results in every request bypassing the cache and proceeding directly to the web-server. This can result in slow delivery of web-pages back to requesters, particularly, during very high frequency periods. In some circumstances, very high request frequencies can result in an unreliable system which produces a denial of service (DoS) for all requesters.

It is an object of the present invention to provide a website application caching mechanism which overcomes the disadvantages of the prior art, or at least provides a useful alternative.

### SUMMARY OF INVENTION

According to a first aspect of the invention there is provided a computer-implemented method for website application caching, including:

a) receiving a POST request from a requester;

b) processing the POST request at a first server;

c) on the basis of the processing, redirecting the POST request to one of a plurality of GET requests;

d) retrieving a first web resource from a cache using the redirected GET request; and

e) transmitting the first web resource to the requester.

The plurality of GET requests may be predefined.

The web resources corresponding to the GET requests may be cached on an automatic basis within the cache. The cache may provided by a caching system, such as Varnish.

The method may further include: receiving a GET request for an initial web-page from the requester; and delivering the initial web-page comprising a POST action to the requester; such that the subsequently received POST request corresponds to the POST action. The POST action may be configured for a different URL to the initial web-page.

The method may further include: adding the POST request to a queue for further processing by a second server; such that at least part of the further processing occurs after the first web-page is transmitted to the requester. The second server may be an application server.

The processing may include one or more validation checks on the POST request.

The first server may be a web server.

In one embodiment, no data is returned to the requester directly from the POST request.

The cached first web resource may be transmitted to a plurality of requesters.

According to a further aspect of the invention there is provided a system for website application caching, including:

one or more servers;

a caching system;

wherein the system is configured for performing the method of the first aspect

Other aspects of the invention are described within the claims.

### BRIEF DESCRIPTION OF THE DRAWINGS

Embodiments of the invention will now be described, by way of example only, with reference to the accompanying drawings in which:

FIG. 1: shows a block diagram of a system in accordance with an embodiment of the invention; and

FIG. 2: shows a flow diagram of a method in accordance with an embodiment of the invention.

### DETAILED DESCRIPTION OF PREFERRED EMBODIMENTS

The present invention provides a method and system for website application caching.

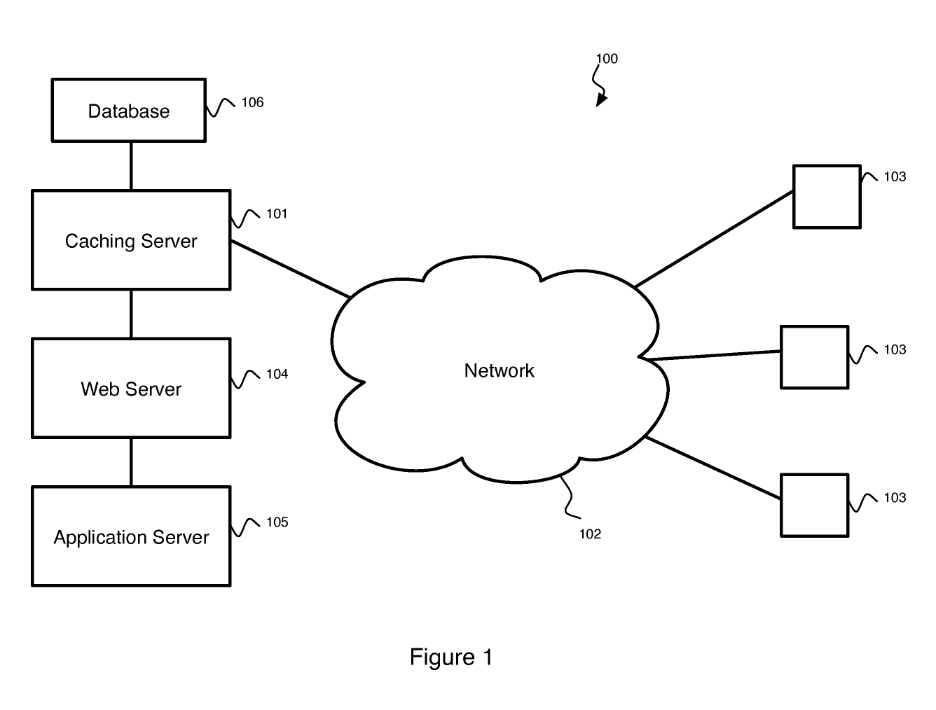

In FIG. 1, a system 100 in accordance with an embodiment of the invention is shown.

A caching system 101 is shown. The caching system 101 is configured to receive HTTP requests either directly via the communications network 102 or via an intermediary server (not shown). The requests are received from a plurality of requester apparatuses 103.

A web server 104 is shown. The web server 104 is configured to receive HTTP requests via the caching server 101 and to process HTTP requests.

An application server 105 is shown. The application server 105 is configured to receive information from the web server 104 derived from the HTTP requests and to process this information.

The web server 104 is further configured to receive and process POST requests, for example, by applying one or more validation checks. On the basis of that processing, the web server 104 is further configured to redirect the POST request to one of a plurality of GET requests. Each GET request includes a URL to a web resource, such as web-page.

The caching system 101 is further configured to cache GET requests by, for example, storing the associated web resource in a caching database 106.

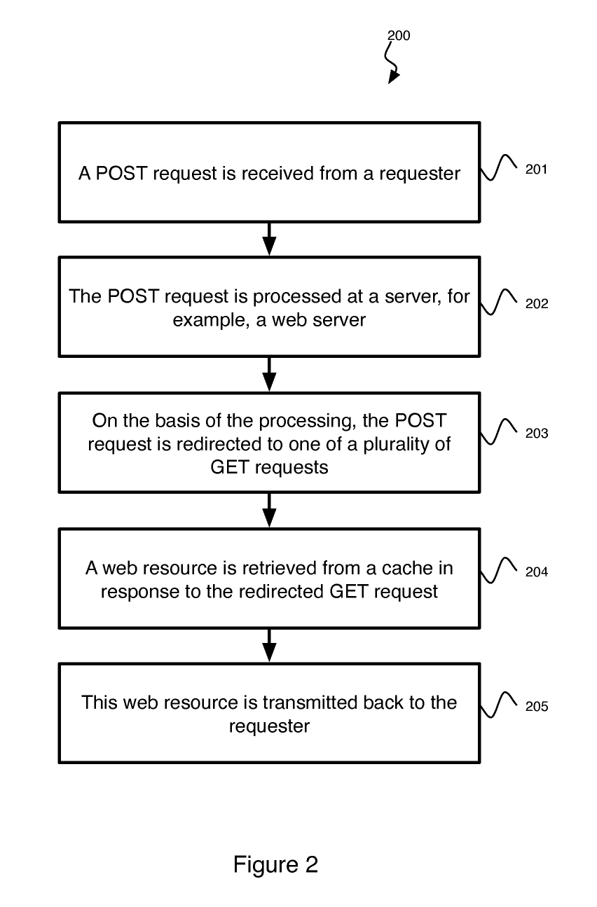

With reference to FIG. 2, a method 200 in accordance with an embodiment of the invention will be described.

In step 201, a POST request is received by, for example, the caching system, from a requester apparatus. The POST request may be forwarded to the web server for processing.

In step 202, the POST request is processed at the web server.

In step 203, on the basis of the processing, the POST request is redirected to one of a plurality of GET requests. This redirection information may be transmitted back to the requester apparatus which requests the redirected GET. The GET requests may be predefined.

In step 204, a first web resource, such as a web-page, is retrieved from a cache using the redirected GET request. The cache may be stored in a caching system. In an alternative embodiment, the web server includes its own cache. An exemplary caching system technology is Varnish. In one embodiment, the caching system may cache the web resources automatically via previously received GET requests. In an alternative embodiment, the cache is pre-populated with web resources for the plurality of GET requests.

In step 205, the first web resource is transmitted back to the requester apparatus. The first web resource may remain in the cache to be able to be transmitted to a plurality of subsequent requesters.

Information relating to the POST request may be processed further after the first web resource has been transmitted back to the requester apparatus. In one embodiment, this information is added to a queue for further processing. The web server may transmit the information to an application server for further processing. In this way, a fast response may be provided to the requester apparatus relating to preliminary processing of the POST request while more intensive processing of the information contained within the POST request is possible.

In one embodiment, the web server first transmits an initial web-page to the requester apparatus containing the POST action. The POST action may be, for example, a form submission action. The requester apparatus may then actuate the POST action to make the POST request of the system. The POST action may refer to a different URL than the URL of the initial web-page.

Exemplary validation testing and redirecting code is provided below:

```
def submit( ):
    ″″″
    Submits the user's registration data.
    ″″″
    if settings[‘switches’].get(‘disable_registration’,
False):
        return redirect(url_for(‘error’))
    cleaned_form = validation.clean_form( )
    if not cleaned_form:
        return redirect(url_for(‘error’))
    birth_date = datetime.date(
        int(cleaned_form[‘year’]),
        int(cleaned_form[‘month’]),
        int(cleaned_form[‘day’])
    )
    try:
        was_registered_now = registration_utils.register(
            email=cleaned_form[‘email’],
            username=cleaned_form[‘username’],
            password=cleaned_form[‘password’],
            dob=birth_date,
game_stock_control_id=settings[‘promotion’][‘free_game’][
‘sku’],
            ip_address=request.remote_addr,
            platforms=cleaned_form.getlist(‘platform’)
        )
    except registration_utils.FailAuth:
        logging.info(‘REGISTER %s: Fail auth’,
cleaned_form[‘email’])
        return redirect(url_for(‘error-incorrect-
credentials’))
    except registration_utils.UsernameTaken:
        logging.info(‘REGISTER %s: Shop username taken’,
cleaned_form[‘email’])
        return redirect(url_for(‘error-username’))
    except (
        MySQLdb.IntegrityError,
        MySQLdb.OperationalError,
        psycopg2.IntegrityError,
        psycopg2.InternalError,
        registration_utils.RegistrationException
    ):
        logging.exception(‘REGISTER %s: Error page’,
cleaned_form[‘email’])
        return redirect(url_for(‘error’))
    if not was_registered_now:
        return redirect(url_for(‘already-registered’))
    return redirect(url_for(‘thanks’))
```

A potential advantage of some embodiments of the present invention is that web resources delivered in response to POST requests can be cached. The consequence of this is a faster, more reliable web server apparatus that is particularly stable when managing large traffic spikes.

While the present invention has been illustrated by the description of the embodiments thereof, and while the embodiments have been described in considerable detail, it is not the intention of the applicant to restrict or in any way limit the scope of the appended claims to such detail. Additional advantages and modifications will readily appear to those skilled in the art. Therefore, the invention in its broader aspects is not limited to the specific details, representative apparatus and method, and illustrative examples shown and described. Accordingly, departures may be made from such details without departure from the spirit or scope of applicant's general inventive concept.

1. A computer-implemented method for website application caching, including:
a) receiving a POST request from a requester;
b) processing the POST request at a first server;
c) on the basis of the processing, redirecting the POST request to one of a plurality of GET requests;
d) retrieving a first web resource from a cache using the redirected GET request; and
e) transmitting the first web resource to the requester.

2. A method as claimed in claim 1, wherein the plurality of GET requests is predefined.

3. A method as claimed in claim 1, wherein web resources corresponding to the GET requests are cached on an automatic basis within the cache.

4. A method as claimed in claim 1, wherein the cache is provided by a caching system.

5. A method as claimed in claim 4, wherein the caching system is Varnish.

6. A method as claimed in claim 1, further including:
receiving a GET request for an initial web-page from the requester; and
delivering the initial web-page comprising a POST action to the requester;
wherein the subsequently received POST request corresponds to the POST action.

7. A method as claimed in claim 6, wherein the POST action is configured for a different URL to the initial web-page.

8. A method as claimed in claim 1, further including:
adding the POST request to a queue for further processing by a second server;
wherein at least part of the further processing occurs after the first web resource is transmitted to the requester.

9. A method as claimed in claim 8, wherein the second server is an application server.

10. A method as claimed in claim 1, wherein the processing includes one or more validation checks on the POST request.

11. A method as claimed in claim 1, wherein the first server is a web server.

12. A method as claimed in claim 1, wherein no data is returned to the requester directly from the POST request.

13. A method as claimed in claim 1, wherein the cached first web resource is transmitted to a plurality of requesters.

14. A system for website application caching, including:
one or more servers;
a caching system;
wherein the system is configured for performing the method of claim 1.
